(19) United States
(12) Patent Application Publication
(10) Pub. No.: US 2012/0171999 A1
(43) Pub. Date: Jul. 5, 2012

(54) APPARATUS AND METHOD FOR PROVIDING SOCIAL NETWORK SERVICE IN PORTABLE TERMINAL

(75) Inventor: Hye-Mi Im, Uijeongbu-si (KR)

(73) Assignee: SAMSUNG ELECTRONICS CO., LTD., Suwon-si (KR)

(21) Appl. No.: 13/343,438

(22) Filed: Jan. 4, 2012

(30) Foreign Application Priority Data
Jan. 4, 2011 (KR) 10-2011-0000374

(51) Int. Cl. H04L 9/32; H04W 12/06

(52) U.S. Cl. 455/411; 726/7

(57) ABSTRACT

An apparatus and a method provide a social network service in a portable terminal. The apparatus includes an input unit that allows selection of a login method for accessing the social network service; a login information generating unit that generates login information using information capable of identifying a user when user identification is required in the selected login method and generates the login information by using information capable of identifying a device when the user identification is not required in the selected login method; a controller that determines whether the user identification is required in the selected login method and generates the login information according to the selected login method; and an application executing unit that executes the social network service by using the generated login information.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jan. 4, 2011 and assigned Serial No. 10-2011-0000374, the entire disclosure of which is hereby incorporated by reference.

### TECHNICAL FIELD OF THE INVENTION

The present invention relates to an apparatus and a method for simplifying a login process of a social network service in a portable terminal. More particularly, the present invention relates to an apparatus and a method for simplifying a login process of a social network service by using login information capable of identifying a user instead of using login information capable of identifying a device.

### BACKGROUND OF THE INVENTION

Recently, a portable terminal has become a necessity in a modem life, enjoyed by persons regardless of age or gender. Accordingly, service providers and portable terminal manufacturers competitively develop products (or services) that can differentiate themselves from others.

For example, the portable terminal has developed into a multimedia device in which a phonebook, game, SMS, e-mail, wake-up call, MP3, calendar, digital camera, multimedia messaging and wireless internet service are available, to provide a variety of services.

Due to recent development of wireless internet services, an online social network service is in a widespread use to the extent that a majority of internet users use a social network service (SNS). The online social network service provides an environment in which each user can actively share and spread personal information and a wide variety of content information (e.g., videos, pictures and SMS). Users of the online social network service can form and maintain networking relationships (friendship) by sharing the personal information over the network.

Recently, users use multiple social network services such as Twitter, Facebook, MySpace, Foursquare, or mini homepage by using a single portable terminal. Namely, the portable terminal has a number of social network services installed thereon and, to access each service, a login process of a corresponding service needs to be carried out.

In order to solve a problem that the login process needs to be carried out for each service in the portable terminal, an automatic login service is provided to maintain a login state of a service, which is once logged in to, until the service is logged out. In other words, when the user of the portable terminal using Twitter wants to check messages or phone book, Twitter service needs to be terminated. When the user uses the Twitter service again, the login process needs to be performed again; however, by using the automatic login feature, the login process can be omitted.

When logging in to the social network service, the automatic login feature as described above uses login information that is called persist key, which can identify a terminal. In other words, the portable terminal transmits to the server the login information, generated by using unique device identification information (IMEI) and unique information of a SIM card, and receives from the server information of the social network service, which is logged in to based on the received login information. Thus, a re-login process for a corresponding service can be omitted.

However, the login information of the terminal is created by using the unique IMEI of the portable terminal, as described above, to identify the portable terminal that uses the social network service.

Recently, users of the portable terminal have multiple devices and use the social network service installed on different devices by replacing the SIM card.

In such a case, the automatic login feature, which uses the login information that can identify the terminal, becomes unavailable because the device is changed. In other words, when the device is changed, the automatic login feature cannot be used even if the user of the portable terminal is the same person.

Accordingly, there is a need for an apparatus and a method of a portable terminal for generating the login information that can identify a user.

### SUMMARY OF THE INVENTION

To address the above-discussed deficiencies of the prior art, it is a primary object to provide at least the advantages described below. Accordingly, an aspect of the present disclosure is to provide an apparatus and a method for simplifying a login process of a social network service in a portable terminal.

Another aspect of the present disclosure is to provide an apparatus and a method for generating information capable of identifying a user in a portable terminal as login information of a social network service.

Another aspect of the present disclosure is to provide an apparatus and a method for generating information capable of identifying a user by using unique information of a SIM card in a portable terminal.

Another aspect of the present disclosure is to provide an apparatus and a method for generating information capable of identifying a user by using authentication information of a user in a portable terminal.

Another aspect of the present disclosure is to provide an apparatus and a method for distinguishing a social application service that performs automatic login based on login information in a portable terminal.

In accordance with an aspect of the present disclosure, an apparatus for providing a social network service in a portable terminal, the apparatus comprising: an input unit configured to allow selection of a login method for accessing the social network service; a login information generating unit configured to generate login information by using information capable of identifying a user when user identification is required in the selected login method and configured to generate the login information by using information capable of identifying a device when the user identification is not required in the selected login method; a controller configured to determine whether the user identification is required in the selected login method and configured to generate the login information according to the selected login method; and an application executing unit configured to execute the social network service by using the generated login information.

In accordance with another aspect of the present disclosure, a method for providing a social network service in a portable terminal, the method comprising: receiving a selection of a login method for accessing the social network service; determining whether user identification is required the selected login method; generating login information by using information capable of identifying a user when the user identification is required in the selected login method; generating the login information by using information capable of identifying a device when the user identification is not required in the selected login method; and accessing the social network service by using the generated login information.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a block diagram of a portable terminal that generates login information capable of identifying a user according to an exemplary embodiment of the present disclosure;

FIG. 2 illustrates a method of generating login information for automatic login to a social network service in a portable terminal according to an exemplary embodiment of the present disclosure;

FIG. 3 illustrates a method of generating login information capable of identifying a user in a portable terminal according to an exemplary embodiment of the present disclosure;

FIG. 4 illustrates a method of generating login information capable of identifying a user in a portable terminal according to another exemplary embodiment of the present disclosure;

FIG. 5 illustrates a method of using a social network service in a portable terminal according to an exemplary embodiment of the present disclosure;

FIG. 6(a) illustrates a screen that outputs multiple login methods in a portable terminal according to an exemplary embodiment of the present disclosure;

FIG. 6(b) illustrates a screen that outputs an automatic login service item according to a login method in a portable terminal according to an exemplary embodiment of the present disclosure; and

FIG. 6(c) illustrates a screen that displays login information generated by using authentication information in a portable terminal according to an exemplary embodiment of the present disclosure.

Throughout the drawings, like reference numerals will be understood to refer to like parts, components and structures.

### DETAILED DESCRIPTION OF THE INVENTION

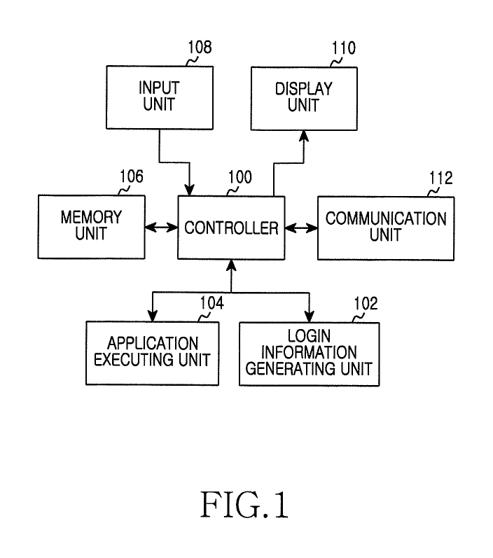

FIGS. 1 through 6(c), discussed below, and the various embodiments used to describe the principles of the present disclosure in this patent document are by way of illustration only and should not be construed in any way to limit the scope of the disclosure.

Exemplary embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the teens may vary depending on user's or operator's intension and usage. That is, the terms used herein must be understood based on the descriptions made herein.

Hereinafter, an apparatus and a method for simplifying a login process of a social network service by using login information capable of identifying a user in a portable terminal are described. The login information refers to information called persist key and is different from actual login information of a social network service.

FIG. 1 illustrates a block diagram of a portable terminal that generates login information capable of identifying a user according to an exemplary embodiment of the present disclosure.

Referring to FIG. 1, the portable terminal can be configured to include a controller 100, a login information generating unit 102, an application executing unit 104, a memory unit 106, an input unit 108, a display unit 110 and a communication unit 112.

First, the controller 100 of the portable terminal is used to control an overall operation of the portable terminal. For example, the controller 100 can handle processing and control for voice call and data communication. Also, in addition to basic features, the controller 100 can create the login information of the social network service by using information capable of identifying a user according to the present disclosure. In other words, the controller 100 controls to generate the persist key for use in an automatic login feature of the social network service by using information capable of identifying a user.

The purpose of this can be to allow the user of the portable terminal to use the automatic login feature even when the user changes a device to use the social network service.

Also, when it is detected that the social network service is logged onto by the login information capable of identifying a user, the controller 100 controls such that the automatic login feature may only be performed for a service set up in the login information.

The login information generating unit 102, under the control of the controller 100, generates the login information of the social network service and uses the information capable of identifying a user in generating the login information according to the present disclosure.

The purpose of this is to solve a problem of a prior art that, when the login information capable of identifying a device is used, the automatic login feature cannot be performed in case the user changes a device.

Here, the login information generating unit 102 can generate the login information according to ‘1 SIM & 1 device’ approach, ‘1 SIM & multi device’ approach, or ‘multi SIM & multi device’ approach.

In the ‘1 SIM & 1 device’ approach, the login information is generated to be used in an example where the user uses one device by using one SIM card. In this approach, user identification is not needed, and therefore, the login information is generated by using information in the prior art such as, for example, IMEI that can identify a device.

In addition, in the ‘1 SIM & multi device’ approach, the login information is generated to be used in an example where the user uses multiple devices by using one SIM card. In this approach, user identification is needed, and therefore, the login information is generated by using information capable of identifying a user such as a telephone number of the portable terminal or the unique information of the SIM card.

Further, in the ‘multi SIM & multi device’ approach, the login information is generated to be used in an example where the user uses multiple devices by using multiple SIM cards. In this approach, user identification is needed, and therefore, the login information is generated by using information capable of identifying a user such as ID and password.

Further, when generating the login information, the login information generating unit 102 sets up the social network service that performs the automatic login feature so that only the social network service that has been set up may be able to perform the automatic login feature.

The application executing unit 104, under the control of the controller 100, performs the social network service that the user wants to execute. Additionally, the application executing unit 104 performs the automatic login feature on the social network service that is set up by the log information generating unit 102.

The memory unit 106 of the portable terminal includes at least one of read-only memory (ROM), random-access memory (RAM), and flash ROM. The ROM stores micro codes and various reference data of a program for processing and controlling the controller 100, the log information generating unit 102 and the application executing unit 104.

The RAM, which is a working memory of the controller 100, stores temporary data generated during execution of various programs. In addition, the Flash ROM stores data such as, for example, a phone book, messages sent and received, and a touch input point of the user, which can be updated. Further, the memory unit 106 stores the login information capable of identifying a user that is generated by the login information generating unit 102, according to the present disclosure.

The input unit 108 includes numerous functions such as, for example, number buttons for 0 to 9, “menu” button, “cancel” button, “OK” button, “call” button, “exit” button, “internet” button, or a navigation key (or arrow key). A key input data corresponding to a key pressed by the user is provided to the controller 100 and an input data can be generated, wherein the input data corresponds to information that is needed to generate the login information for identifying the user according to the present disclosure.

The display unit 110 displays, for example, status information, a limited number of characters, and a high volume of videos and still images, which are generated during operation of the mobile terminal, and outputs a screen to receive information that is needed to generate the login information according to the present disclosure. The display unit 110 can be implemented by, for example, using a color liquid crystal display (LCD) device or an active matrix organic light emitting diode (AMOLED). The display unit 110 can be used as an input device when the display unit 110 is equipped with a touch input device and is applied to a portable device having a touch input mode.

The communication unit 112 performs a function to transmit and receive a wireless signal of a data, which is input or output through an antenna (not shown). For example, in an example of transmission of data, a channel coding and spreading is performed on a data to be transmitted, which is then RF processed and transmitted. In an example of receipt of data, a received RF signal is converted to a baseband signal and despreading and channel decoding is performed on the baseband signal to restore the data.

The functions of the log information generating unit 102 and the application executing unit 104 can be performed by the controller 100 of the portable terminal 100; however, for illustrative purposes, the log information generating unit 102 and the application executing unit 104 are described as separate units, and this example should not be construed as limiting the scope of the present disclosure. Various modifications will be apparent to those skilled in the art within the scope of the disclosure. For example, the controller 100 can be configured to process all the functions described above.

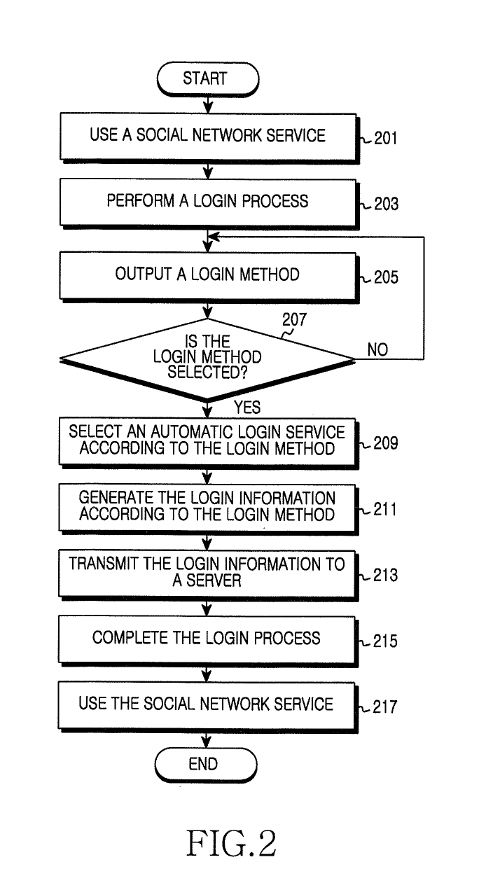

FIG. 2 illustrates a method of generating login information for automatic login to a social network service in a portable terminal according to an exemplary embodiment of the present disclosure.

Referring to FIG. 2, the login information refers to information for automatically maintaining a login state of the social network service (SNS) until the user is logged out, instead of the actual login information of the social network service.

The user of the portable terminal can terminate the social network service without logging out, and after a certain period of time, the user can rerun to the service without performing a login process again.

The portable terminal for generating the login information, described above, first executes the social network service in step 210. Here, the social network service, which allows the user to build a human network on the Internet over a web application, includes, for example, Twitter, mini homepage, blog, Facebook, Foursquare, and MySpace.

The portable terminal that executes the social network service outputs a login screen for the executed service and proceeds to step 203 to perform the login process.

Here, the portable terminal can generate the login information in various methods according to the present disclosure, which will be described in detail.

In order to perform the login process described above, the portable terminal proceeds to step 205 to output a screen displaying multiple login methods.

Here, according to an exemplary embodiment of the present disclosure, the login method can be defined in three ways.

First, the ‘1 SIM and 1 device’ method is a method in which the login information is generated to be used in an example where the user uses a single device with a single SIM card.

Second, the ‘1 SIM & multi device’ method is a method in which the login information is generated to be used in an example where the user uses multiple devices by a single SIM card.

Third, the ‘multi SIM & multi device’ method is a method in which the login information is generated in an example where the user uses multiple devices with multiple SIM cards.

As described above, the login method is defined considering that the user of the portable device uses multiple devices instead of a single device. When the login information is created in a conventional method to identify a device and the user uses other device, the automatic login feature for the social network service becomes unavailable.

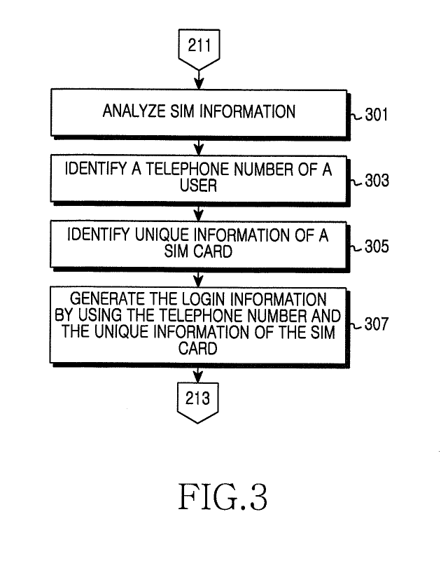

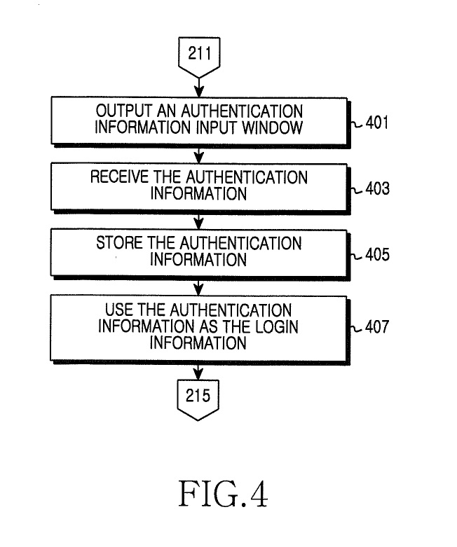

Accordingly, the portable device in accordance with the present disclosure generates the login information that can identify a user so that automatic login feature can be performed continuously even when a device is changed. The method of generating the login information according to each login method will be described with reference to FIGS. 3 and 4.

The portable terminal that outputs the screen displaying the multiple login methods as described above proceeds to step 207 to detect selection by the user of the login method.

When the selection of the login method is not detected in step 207, the portable terminal performs step 205 again.

Meanwhile, when it is detected that the login method is selected in step 207, the portable terminal proceeds to step 209 to allow the user to select an automatic login service according to the selected login method. Here, the automatic login service according to the login method refers to the social network service that enables the automatic login feature. Namely, the portable terminal may only perform automatic login for a certain service among social network services.

Next, the portable terminal proceeds to step 211 to generate the login information corresponding to the login method selected in step 207. When the user of the portable terminal selects a method for multiple devices in step 207, the portable terminal generates the login information capable of identifying a user instead of the login information capable of identifying a device in step 211, according to the present disclosure.

Next, the portable terminal proceeds to step 213 to transmit the login information generated in step 211 to a server that manages the login information, and then the portable terminal proceeds to step 215 to complete the login process.

Next, the portable terminal proceeds to step 217 to use the social network service executed in step 201 and then terminates a current algorithm.

FIG. 3 illustrates a method of generating login information capable of identifying a user in a portable terminal according to an exemplary embodiment of the present disclosure.

Referring to FIG. 3, a process of generating the login information is an example embodiment of step 211 in FIG. 2, in which the login information is generated to be used in an example where the user uses multiple devices with one SIM card.

The portable terminal for generating the login information described above first performs a process of analyzing information of the SIM card in step 301.

Next, the portable terminal proceeds to step 303 to identify a telephone number of the user and proceeds to step 305 to identify unique information of the SIM card.

Next, the portable terminal proceeds to step 307 to generate the login information by using the telephone number and the unique information of the SIM card. The login information as described above identifies a user by using SIM card information and can identify a user even when the SIM card is mounted to other device to use the social network service. Accordingly, the user of the portable terminal can use the automatic login feature when using the social network service on multiple devices as long as the same SIM card is used.

Next, the portable terminal performs step 213 of FIG. 2.

FIG. 4 illustrates a method of generating login information capable of identifying a user in a portable terminal according to another exemplary embodiment of the present disclosure.

Referring to FIG. 4, the process of generating the login information is another embodiment of step 211 in FIG. 2, in which the login information is generated to be used in an example where the user uses multiple devices with multiple SIM cards.

The portable terminal for generating the login information described above first outputs an authentication information input window in step 401. Here, in order to generate the login information by using authentication information including a user ID and a password, the portable terminal outputs a window for receiving the authentication information.

Next, the portable terminal proceeds to step 403 to receive the authentication information required to generate the login information and proceeds to step 405 to store the received authentication information. Here, the portable terminal stores the authentication information therein instead of transmitting the authentication information to the server, as in the example of the login information generated in FIG. 3, and identifies a user who wants to use social network.

Next, the portable terminal proceeds to step 407 to use the received authentication information as the login information and performs step 215 of FIG. 2.

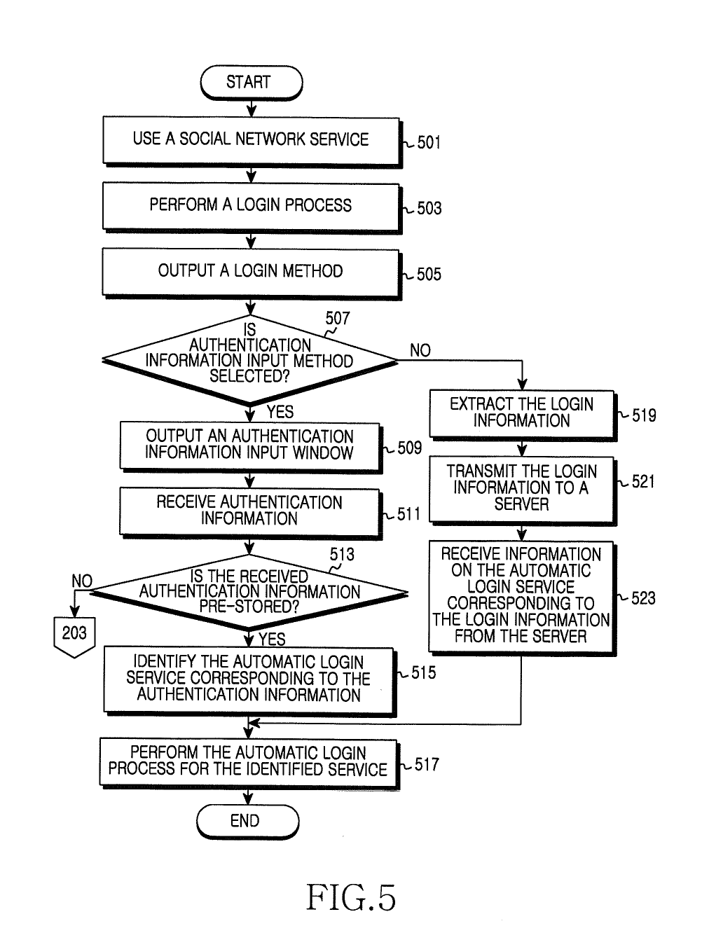

FIG. 5 illustrates a method of using a social network service in a portable terminal according to an exemplary embodiment of the present disclosure.

Referring to FIG. 5, the portable terminal first executes the social network service including, for example, twitter, mini homepage, blog, Facebook, Foursquare, or MySpace in step 501.

The portable terminal that executes the social network service as described above outputs the login screen of the executed service and proceeds to step 503 to perform the login process.

Next, the portable terminal proceeds to step 505 to output a screen displaying multiple login methods.

Next, the portable terminal proceeds to step 507 to determine whether an authentication information input method is selected as the login method of the social network service executed in step 501.

When it is determined that the authentication information input method is selected as the login method of the social network service in step 507, the portable terminal proceeds to step 509 to output the authentication information input window and proceeds to step 511 to receive the authentication information from the user of the portable terminal.

Next, the portable terminal proceeds to step 513 to determine whether the authentication information received from the user is pre-stored. Here, the presence of the received authentication information indicates that information, which is used to automatically maintain the login state after the social network service is logged in to and until the social network service is logged out, has been entered correctly (i.e., the information received is identical with the login information generated in FIG. 4).

When it is determined that the received authentication information is not pre-stored in step 513, the portable terminal proceeds to step 203 of FIG. 2 to perform the login process of the social network service.

On the other hand, when it is determined that the received authentication information is pre-stored in step 513, the portable terminal proceeds to step 515 to identify the automatic login service corresponding to the authentication information. Here, the portable terminal identifies the user by using the authentication information and verifies a social application service for which the automatic login is enabled for the user.

Meanwhile, when it is determined in step 507 that the selected login method of the social network service is a login authentication method using the SIM card information instead of using the received authentication information, the portable terminal proceeds to step 519 to extract the login information from the SIM card, which is mounted within the portable terminal. Here, the portable terminal extracts the telephone number of the portable terminal and the unique information of the SIM card.

Next, the portable terminal proceeds to step 521 to transmit the extracted login information to the server that manages the login information and proceeds to step 523 to receive, from the server, information on the automatic login service corresponding to the login information.

The portable terminal, which identifies the automatic login service corresponding to the login information in step 515 or step 523 as described above, proceeds to step 517 to perform the automatic login process for the identified service.

Next, the portable terminal terminates the current algorithm.

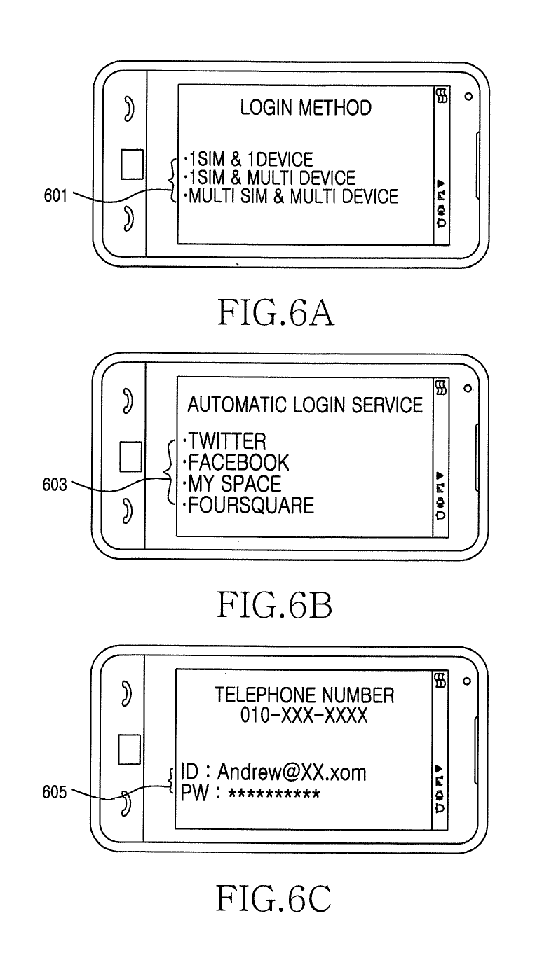

FIGS. 6(a)-(c) illustrate generation of the login information in a portable terminal according to exemplary embodiments of the present disclosure.

FIG. 6(a) illustrates a screen that outputs multiple login methods in a portable terminal according to an exemplary embodiment of the present disclosure.

Referring to FIG. 6 (a), the login method can be defined in three ways (601) including the ‘1 SIM & 1 device’ method, the ‘1 SIM & multi device’ method, and the ‘multi SIM & multi device’ according to an exemplary embodiment of the present disclosure.

First, in the ‘1 SIM & 1 device’ method, the login information is generated to be used in an example where the user uses a single device with a single SIM card. In this method, the login information is generated by using device identification information (IMEI) and the unique information of the SIM card, similarly to the conventional method of generating the login information. When using this method, the portable terminal cannot use the automatic login service when the SIM card is replaced or the user uses other device to execute the social network service. It is because the login information generated is the information capable of identifying a device, and thus, whether the user is identical cannot be identified.

In the ‘1 SIM & multi device’ method, the login information is generated to be used in the example where the user uses multiple devices with a single SIM card. In this method, the login information is generated by using the telephone number of the portable terminal and the unique information of the SIM card. When using this method, in a scenario in which a device A is connected to Facebook, and then the SIM card of the device A is mounted to a device B, from which the user attempts to access Facebook, the user can be automatically logged in to Facebook with the login information that has already been used, thus obviating a need for a separate login process. It is because the login information generated is the information capable of identifying a user and can verify whether a user already connected to Facebook is identical with a user that re-accesses Facebook.

In addition, in the ‘multi SIM & multi device’ method, the login information is generated to be used in an example where a user uses the multiple devices with multiple SIM cards. In this method, the authentication information (ID and password) of the user is entered to be stored in all devices wanted by the user so that the automatic login is to be performed with the pre-stored authentication information. In this example, the user of the portable terminal can use specific information (e.g., email address) of the user as the authentication information in order to avoid duplicate subscription, thereby preventing overlapping of the authentication information between users. It is because the login information generated is the information that can identify the user so that it is possible to verify that a user already connected to Facebook is identical with a user that re-access Facebook.

FIG. 6(b) illustrates a screen that displays automatic login service items according to a login method in a portable terminal according to an exemplary embodiment of the present disclosure.

Referring to FIG. 6 (b), when it is determined that the login method is selected by the user among the login methods outputted in FIG. 6 (a), the portable terminal outputs the automatic login service 603, as shown.

Here, the automatic login service according to the login method refers to a list of the social network service for which the automatic login is to be performed among a plurality of social network services supported by the portable terminal. In other words, the automatic login service refers to the list of the social network service for which the automatic login is to be performed using the login information generated by the login method selected by the user.

The user of the portable terminal selects an item of the service for which the automatic login is to be performed from a screen as shown. When the service is accessed by the login information generated by the method selected in FIG. 6 (a), the automatic login may only be performed for the selected service. For example, when the user of the portable terminal selects to perform the automatic login to only Twitter in the ‘1 SIM & multi device’ method, the automatic login is not to be performed for Facebook when the user accesses to Facebook while Twitter can enable the automatic login.

FIG. 6(c) illustrates a screen that displays the login information generated by using authentication information in a portable terminal according to an exemplary embodiment of the present disclosure.

Referring to FIG. 6(c), the portable terminal generates the login information to be used in an example where the user uses multiple devices with multiple SIM cards.

The portable terminal for generating the login information as described above is to output the authentication information input window as illustrated, and the user is to enter the authentication information 605 including ID and password. Accordingly, the portable terminal generates the login information to be stored by using the authentication information. Here, the generated log information is stored in all devices available to the user of the mobile terminal, instead of being sent to the server that manages the login information.

In addition, the user of the portable terminal uses specific information (e.g., email address) of the user as the authentication information in order to avoid duplicate subscription, thereby preventing overlapping of the authentication information between users.

As described above, according to the present disclosure, the login process of the social network service on the portable terminal can be simplified, wherein the information capable of identifying a user is used as the login information of the social network service so that the automatic login feature can be performed even when the social network service is accessed from a different device.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An apparatus for providing a social network service in a portable terminal, the apparatus comprising:
an input unit configured to receive a selection of a login method for accessing the social network service;
a login information generating unit configured to generate login information using information capable of identifying a user when user identification is required in the selected login method and configured to generate the login information using information capable of identifying a device when the user identification is not required in the selected login method;
a controller configured to determine whether the user identification is required in the selected login method and configured to generate the login information according to the selected login method; and
an application executing unit configured to execute the social network service using the generated login information.

2. The apparatus of claim 1, wherein the login information generating unit is further configured to set a service item for which an automatic login feature is to be performed to skip a login process when generating the login information.

3. The apparatus of claim 1, wherein the controller is further configured to control such that an automatic login feature is performed when the login information is generated using the information capable of identifying the user and a social network service that had previously been accessed from another device is re-accessed.

4. The apparatus of claim 1, wherein the login method for accessing the social network service includes at least one of, a “1 SIM & 1 device” method, a “1 SIM & multi device” method, and a “multi SIM & multi device” method, wherein the “1 SIM & 1 device” method is a method in which the login information is used when the user uses one device with one subscriber identity module (SIM) card, the “1 SIM & multi device” method is a method in which the login information is used when the user uses multiple devices with one SIM card, and the “multi SIM & multi device” method is a method in which the login information is used when the user uses multiple devices with multiple SIM cards.

5. The apparatus of claim 1, wherein the login information generating unit is further configured to identify a telephone number of the user and unique information of a subscriber identity module (SIM) card for identifying the user by analyzing information of the SIM card and to generate the login information using the telephone number and the unique information of the SIM card.

6. The apparatus of claim 1, wherein the login information generating unit is further configured to receive authentication information capable of identifying the user and is configured to use the authentication information as the login information.

7. The apparatus of claim 6, wherein the authentication information is stored in the portable terminal.

8. The apparatus of claim 1, wherein the selected login method used when one subscriber identity module (SIM) card is used with multiple devices, wherein the login information generating unit is further configured to generate the login information using a telephone number of the portable terminal and unique information of the SIM card.

9. The apparatus of claim 1, wherein the selected login method used when multiple subscriber identity module (SIM) cards are used with multiple devices, wherein the login information generating unit is further configured to generate the login information using authentication information of the user that is stored in each of the multiple devices.

10. The apparatus of claim 1, wherein the portable terminal comprises a mobile phone.

11. A method for providing a social network service in a portable terminal, the method comprising:
receiving a selection of a login method for accessing the social network service;
determining whether user identification is required in the selected login method;
generating login information using information capable of identifying a user when the user identification is required in the selected login method;
generating the login information using information capable of identifying a device when the user identification is not required in the selected login method; and
accessing the social network service using the generated login information.

12. The method of claim 11, wherein generating the login information comprises:
setting a service item for which an automatic login feature is to be performed to skip a login process.

13. The method of claim 11 further comprising:
performing an automatic login feature when the login information is generated using the information capable of identifying the user and a social network service that had previously been accessed from another device is re-accessed.

14. The method of claim 11, wherein the login method for accessing the social network service includes at least one of, a “1 SIM & 1 device” method, a “1 SIM & multi device” method, and a “multi SIM & multi device” method, wherein the “1 SIM & 1 device” method is a method in which the login information is used when the user uses one device with one subscriber identity module (SIM) card, the “1 SIM & multi device” method is a method in which the login information is used when the user uses multiple devices with one SIM card, and the “multi SIM & multi device” method is a method in which the login information is used in when the user uses multiple devices with multiple SIM cards.

15. The method of claim 11, wherein generating the login information using the information capable of identifying the user comprises:
analyzing information of a subscriber identity module (SIM) card;
identifying a telephone number of the user;
identifying unique information of the SIM card; and
generating the login information using the telephone number and the unique information of the SIM card.

16. The method of claim 11, wherein generating the login information using the information capable of identifying the user comprises:
outputting a window for receiving authentication information capable of identifying the user;
receiving the authentication information; and
using the received authentication information as the login information.

17. The method of claim 16, wherein the authentication information is stored in the portable terminal.

18. The method of claim 11, wherein the selected login method used when one subscriber identity module (SIM) card is used with multiple devices, wherein generating the login information using the information capable of identifying the user comprises:
generating the login information using a telephone number of the portable terminal and unique information of the SIM card.

19. The method of claim 11, wherein the selected login method used when multiple subscriber identity module (SIM) cards are used with multiple devices, wherein generating the login information using the information capable of identifying the user comprises:
generating the login information using authentication information of the user that is stored in each of the multiple devices.

20. The method of claim 11, wherein the portable terminal comprises a mobile phone.
